(19) United States
(12) Patent Application Publication
(10) Pub. No.: US 2008/0219452 A1
(43) Pub. Date: Sep. 11, 2008

(54) WIRELESS DEVICE AND KEY EXCHANGE METHOD THEREOF

(75) Inventors: CHI-MING LU, Tu-Cheng (TW); GUO-ZHI DING, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/762,788

(22) Filed: Jun. 14, 2007

(30) Foreign Application Priority Data
Mar. 5, 2007 (CN) 200710200247.8

(51) Int. Cl. H04L 9/08

(52) U.S. Cl. 380/283

(57) ABSTRACT

A wireless device (100) for exchanging keys with another wireless device (200) includes a key request module (121), a key generation module (122), and a key transfer module (123). The key request module requests to exchange a key by transmitting a request-key-change frame to the another wireless device. The key generation module generates a new key when the key exchange request is successful. The key transfer module encrypts the new key with a public key of the another wireless device, and transmits a new-key-send frame with the encrypted new key to the another wireless device. A key exchange method is also provided.

### BACKGROUND OF THE INVENTION

1. Field of the Invention

The present invention relates to wireless communications, and particularly to a wireless device and a dynamic key exchange method.

2. Description of Related Art

In an Institute of Electrical and Electronics Engineers (IEEE) 802.11 wireless network, a wireless distribution system (WDS) is used for transferring data between access points (APs). In a conventional method, a Wired Equipment Privacy (WEP) key must be set in two access points by users manually, via user interfaces (UIs) of the two access points in order to establish a WDS connection between the two access points.

However, the WDS connection between the two access points will be insecure if the two access points only support an invariable WEP key. Therefore, users need to frequently and manually change the WEP key of the two access points in order to maintain communication security, which is inconvenient.

### SUMMARY OF THE INVENTION

An exemplary embodiment of the invention provides a wireless device that exchanges dynamic keys with another wireless device. The wireless device includes a key request module, a key generation module, and a key transfer module. The key request module requests to exchange a key by transmitting a request-key-change frame to the another wireless device. The key generation module generates a new key when the key exchange request is successful. The key transfer module encrypts the new key with a public key of the another wireless device, and transmits a new-key-send frame with the encrypted new key to the another wireless device.

Another exemplary embodiment of the invention provides a dynamic key exchange method for exchanging keys between/among a plurality of wireless devices. A first wireless device transmits a request-key-change frame to a second wireless device to request to exchange a key. The second wireless device transmits an agree-key-change frame to the first wireless device to agree to exchange a key. The first wireless device generates a new key and encrypts the new key with a public key of the second wireless device. The first wireless device transmits a new-key-send frame with the encrypted new key to the second wireless device. The second wireless device parses the new-key-send frame to obtain the new key according to a privacy key of the second wireless device. The second wireless device transmits a new-key-received frame to the first wireless device to inform the first wireless device that the new key has been received.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a schematic diagram of an application environment of a key exchange method of an exemplary embodiment of the invention;

FIG. 2 is a schematic diagram of another application environment of a key exchange method of another exemplary embodiment of the invention;

FIG. 3 is a schematic diagram of a management frame of a further exemplary embodiment of the invention;

FIG. 4 is a schematic diagram of a challenge text of a still further exemplary embodiment of the invention;

FIG. 5 is a schematic diagram of another challenge text of a yet further exemplary embodiment of the invention;

FIG. 6 is a schematic diagram of functional modules of a first wireless device and a second wireless device of a yet another further exemplary embodiment of the invention;

FIG. 7 is a flowchart of a key exchange method of a yet still further exemplary embodiment of the invention;

FIG. 8 is a flowchart of details of certain initial steps shown in FIG. 7; and

FIG. 9 is a flowchart of details of remaining steps shown in FIG. 7.

### DETAILED DESCRIPTION OF THE INVENTION

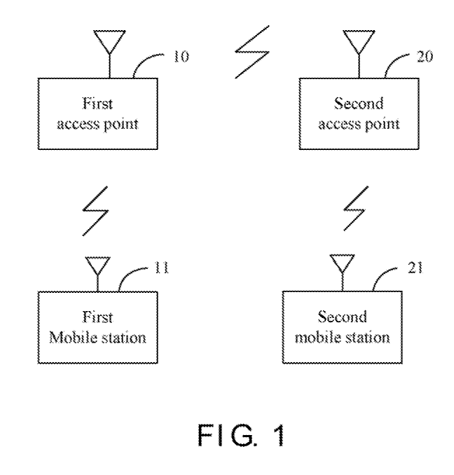

FIG. 1 is a schematic diagram of an application environment of a dynamic key exchange method of an exemplary embodiment of the invention. In the exemplary embodiment, a wireless communication system includes a first access point 10, a second access point 20, a first mobile station 11, and a second mobile station 21. The first mobile station 11 and the second mobile station 21 may be devices that can be connected to a wireless local area network (WLAN), such as notebook computers, mobile phones, personal digital assistants (PDAs), and the like. The first mobile station 11 wirelessly communicates with the first access point 10. The second mobile station 21 wirelessly communicates with the second access point 20.

In the exemplary embodiment, the first access point 10 transmits a request-key-change frame to the second access point 20 to request to exchange a key, and then the second access point 20 transmits an agree-key-change frame to the first access point 10 to agree to exchange a key. Afterwards, the first access point 10 generates a new key, and encrypts the new key with a public key from a certification file of the second access point 20. Then first access point 10 transmits a new-key-send frame with the encrypted new key to the second access point 20, and then the second access point 20 parses the new-key-send frame to obtain the new key according to a privacy key from the certification file of the second access point 20. The second access point 20 transmits a new-key-received frame to the first access point 10 to inform the first access point 10 that the new key has been received. At last, the first access point 10 and the second access point 20 use the new key for data traffic. Thus, the first access point 10 automatically and securely exchanges a key and establishes a wireless distributed system (WDS) connection with the second access point 20.

Therefore, the first mobile station 11 can wirelessly communicate with the second mobile station 21 via the first access point 10 and the second access point 20, and accordingly the scope of the wireless network is expanded from the scope of the first access point 10 or the second access point 20 to the scope of the first access point 10 and the second access point 20.

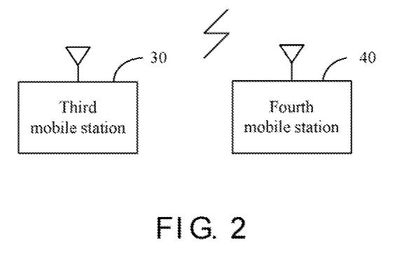

FIG. 2 is a schematic diagram of another application environment of a key exchange method of an exemplary embodiment of the invention. In the exemplary embodiment, a wireless communication system includes a third mobile station 30 and a fourth mobile station 40. The third mobile station 30 transmits a request-key-change frame to the fourth mobile station 40 to request to exchange a key, and then the fourth mobile station 40 transmits an agree-key-change frame to the third mobile station 30 to agree to exchange a key. Afterwards, the third mobile station 30 generates a new key, and encrypts the new key with a public key of the fourth mobile station 40. The third mobile station 30 transmits a new-key-send frame with the encrypted key to the fourth mobile station 40, and then the fourth mobile station 40 parses the new-key-send frame to obtain the new key according to a privacy key of the fourth mobile station 40. The fourth mobile station 40 transmits a new-key-received frame to the third mobile station 30 to inform the third mobile station 30 that the new key has been received. At last, the third mobile station 30 and the fourth mobile station 40 use the new key for data traffic. Thus, the third mobile station 30 automatically and securely exchanges a key and establishes a point-to-point connection with the fourth mobile station 40.

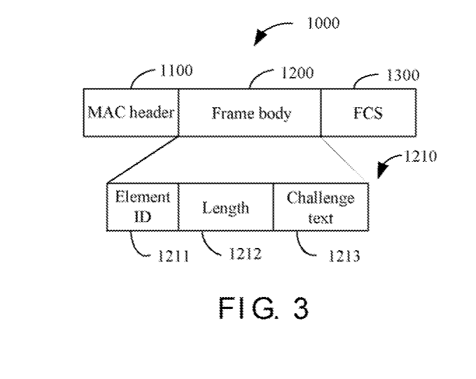

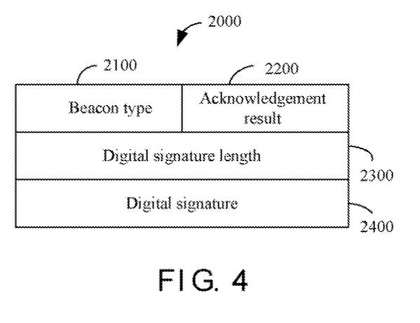

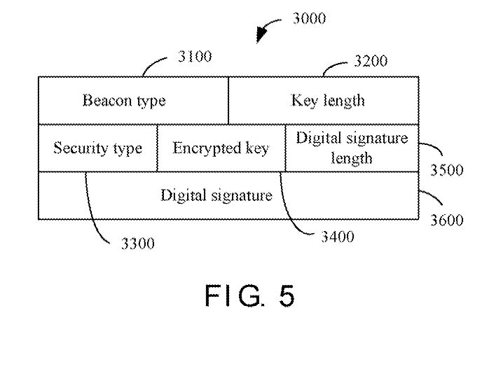

FIG. 3 is a schematic diagram of a management frame 1000 of an exemplary embodiment of the invention. In the exemplary embodiment, the management frame 1000 is a beacon frame, and includes a media access control (MAC) header 1100, a frame body 1200, and a frame check sequence (FCS) 1300. The MAC header 1100 is set according to a MAC header of a beacon frame defined by the institute of electrical and electronics engineers (IEEE) 802.11 protocol. The frame body 1200 includes a plurality of information elements (IEs) 1210. Each IE 1210 includes an element identifier (ID) 1211, a length 1212, and a challenge text 1213. In this embodiment, when the contents of challenge text 1213 of one IE 1210 are set as a challenge text 2000 shown in FIG. 4, the management frame 1000 with the IE 1210 is a request-key-change frame, an agree-key-change frame, or a new-key-received frame. When the contents of the challenge text 1213 of one IE 1210 are set as a challenge text 3000 shown in FIG. 5, the management frame 1000 with the IE 1210 is a new-key-send frame. The challenge text 2000 and the challenge text 3000 will be described hereinafter.

FIG. 4 is a schematic diagram of the challenge text 2000 of an exemplary embodiment of the invention. In the exemplary embodiment, the challenge text 2000 includes a beacon type 2100, an acknowledgement result 2200, a digital signature length 2300, and a digital signature 2400.

In other embodiments, the challenge text 2000 may include other fields according to different requirements.

The beacon type 2100 indicates a type of the management frame 1000 with the challenge text 2000. In this embodiment, when the beacon type 2100 is set to 1, the management frame 1000 with the challenge text 2000 is the request-key-change frame. When the beacon type 2100 is set to 2, the management frame 1000 with the challenge text 2000 is the agree-key-change frame. When the beacon type 2100 is set to 4, the management frame 1000 with the challenge text 2000 is the new-key-received frame.

It should be noted that the relationship between the settings of the beacon type 2100 and the type of the management frame 1000 with the challenge text 2000 are not restricted to the above relationship, and may be changed according to different requirements.

The acknowledgement result 2200 indicates acceptance or rejection. In this embodiment, the acknowledgement result 2200 may be set to 0, indicating acceptance or the acknowledgement result 2200 may be set to 1, indicating rejection. When the management frame 1000 is the request-key-change frame, the acknowledge result 2200 is insignificant, and does not need to be set. When the management frame 1000 is the agree-key-change frame, the acknowledgement result 2200 may be set to 0 or 1, respectively indicating accepting the key exchange request or rejecting the key exchange request. When the management frame 1000 is the new-key-received frame, the acknowledgement result 2200 is only set to 0, indicating that the new key has been received.

The digital signature length 2300 indicates a length of the digital signature 2400. The digital signature 2400 is a digital signature encrypted with a privacy key of a transmitter. In the exemplary embodiment, the transmitter is a device transmitting the management frame 1000 with the challenge text 2000, and a receiver is a device receiving the management frame 1000 with the challenge text 2000. When receiving the management frame 1000 with the challenge text 2000, the receiver checks the digital signature 2400 according to a public key of the transmitter, thereby assuring secure communication between the transmitter and the receiver.

FIG. 5 is a schematic diagram of the challenge text 3000 of an exemplary embodiment of the invention. In the exemplary embodiment, the challenge text 3000 includes a beacon type 3100, a key length 3200, a security type 3300, an encrypted key 3400, a digital signature length 3500, and a digital signature 3600.

In other embodiments, the challenge text 3000 may include other fields according to different requirements.

The beacon type 3100 indicates a type of the management frame 1000 with the challenge text 3000. In the embodiment, the beacon type 3100 is set to 3, indicating the management frame 1000 with the challenge text 3000 is the new-key-send frame.

The key length 3200 indicates lengths of the security type 3300 and the encrypted key 3400. The security type 3300 indicates a type of the new key in the challenge text 3000. In the exemplary embodiment, when the security type 3300 is set to 0, the new key in the challenge text 3000 is a wired equivalent privacy (WEP) key. When the security type 3300 is set to 1, the new key carried in the challenge text 3000 is a Wi-Fi protected access pre-shared key (WPA-PSK). When the security type 3300 is set to 2, the new key is a Wi-Fi protected version 2 access pre-shared key (WPA2-PSK).

The encrypted key 3400 indicates the new key encrypted with a public key of a receiver. In the exemplary embodiment, the receiver is a device receiving the management frame 1000 with the challenge text 3000, and a transmitter is a device transmitting the management frame 1000 with the challenge text 3000. The transmitter encrypts the new key with the public key of the receiver, and the receiver decrypts the encrypted new key with a privacy key of the receiver to obtain the new key. Thus the new key is safely transmitted from the transmitter to the receiver.

The digital signature length 3500 indicates a length of the digital signature 3600. The digital signature 3600 is a digital signature encrypted with a privacy key of the transmitter. When receiving the management frame 1000 with challenge text 3000 from the transmitter, the receiver checks the digital signature 3600 according to a public key of the transmitter, thereby assuring communication security between the transmitter and the receiver.

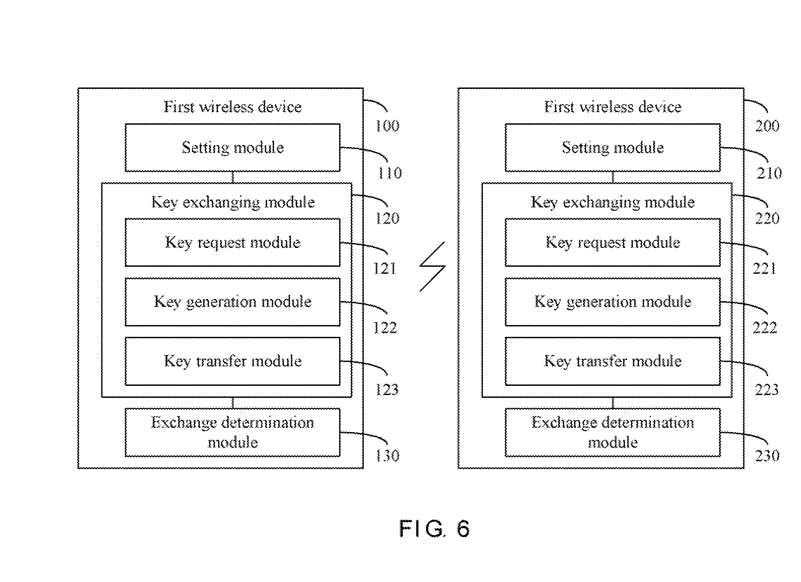

FIG. 6 is a schematic diagram of functional modules of a first wireless device 100 and a second wireless device 200 of an exemplary embodiment of the invention. In the exemplary embodiment, the first wireless device 100 and the second wireless device 200 may respectively be the first access point 10 and the second access point 20, or respectively be the third mobile station 30 and the fourth mobile station 40.

The first wireless device 100 includes a setting module 110, a key exchanging module 120, and an exchange determination module 130. The second wireless device 200 includes a setting module 210, a key exchanging module 220, and an exchange determination module 230. The key exchanging module 120 (220) further includes a key request module 121 (221), a key generation module 122 (222), and a key transfer module 123 (223).

In other embodiments, the first wireless device 100 may directly include the setting module 110, the key request module 121, the key generation module 122, the key transfer module 123, and the exchange determination module 130. Accordingly, the second wireless device 200 may also directly include the setting module 210, the key request module 221, the key generation module 222, the key transfer module 223, and the exchange determination module 230.

The setting module 110 of the first wireless device 100 sets a certification file and a MAC address of the second wireless device 200. The setting module 210 of the second wireless device 200 sets a certification file and a MAC address of the first wireless device 100. In the exemplary embodiment, the certification file of the second wireless device 200 includes a public key of the second wireless device 200. The certification file of the first wireless device 100 includes a public key of the first wireless device 100.

In the exemplary embodiment, if the first wireless device 100 establishes a WDS connection with the second wireless device 200, the setting module 110 of the first wireless device 100 sets the MAC address of the second wireless device 200, and the setting module 210 of the second wireless device 200 sets the MAC address of the first wireless device 100.

In another exemplary embodiment, if the first wireless device 100 establishes a point-to-point connection with the second wireless device 200, the setting module 110 of the first wireless device 100 does not need to set the MAC address of the second wireless device 200, and the setting module 210 of the second wireless device 200 does not need to set the MAC address of the first wireless device 100.

The key exchanging module 120 of the first wireless device 100 exchanges a key with the second wireless device 200. The key exchanging module 220 of the second wireless device 200 exchanges a key with the first wireless device 100.

In the exemplary embodiment, the first wireless device 100 actively requests to exchange a key with the second wireless device 200. The key request module 121 transmits a request-key-change frame to the second wireless device 200 to request to exchange a key. The key request module 221 transmits an agree-key-change frame to the first wireless device 100 to agree to exchange a key.

In detail, the key request module 121 transmits the request-key-change frame to the second wireless device 200 according to a privacy key of the first wireless device 100. The request-key-change frame is the management frame 1000 with the challenge text 2000. Referring to FIG. 4, the beacon type 2100 of the challenge text 2000 is set to 1, indicating the type of the request-key-change frame. The digital signature length 2300 is a length of the digital signature 2400. The digital signature 2400 is a digital signature encrypted with the privacy key of the first wireless device 100.

The key request module 221 receives the request-key-change frame, and checks the request-key-change frame according to a public key of the first wireless device 100. In the exemplary embodiment, the key request module 221 checks the digital signature 2400 of the request-key-change frame according to the public key of the first wireless device 100.

Then the key request module 221 transmits the agree-key-change frame to the first wireless device 100 according to a privacy key of the second wireless device 200. The agree-key-change frame is the management frame 1000 with the challenge text 2000. Referring to FIG. 4, the beacon type 2100 of the challenge text 2000 is set to 2, indicating the type of the agree-key-change frame. The acknowledgement result 2200 is set to 0, indicating acceptance of the key exchange request. The digital signature length 2300 indicates a length of the digital signature 2400. The digital signature 2400 is a digital signature encrypted with the privacy key of the second wireless device 200.

The key request module 121 receives the agree-key-change frame, and checks the agree-key-change frame according to a public key of the second wireless device 200. In this embodiment, the key request module 121 checks the digital signature 2400 of the agree-key-change frame according to the public key of the second wireless device 200.

In other embodiments, the second wireless device 200 may actively request to exchange a key with the first wireless device 100, and accordingly the functions of the key request modules 121 and 221 may be exchanged.

In the exemplary embodiment, the key generation module 122 generates a new key when the key exchange request is successful. The new key is a WEP key. The first wireless device 100 generates the WEP key according to the IEEE 802.11 protocol.

In other embodiments, the new key may be a WPA-PSK or a WPA2-PSK, and the first wireless device 100 may generate the WPA-PSK or the WPA2-PSK according to the IEEE 802.11i protocol.

The key transfer module 123 encrypts the new key with the public key of the second wireless device 200, and transmits a new-key-send frame with the encrypted new key to the second wireless device 200. The key transfer module 223 transmits a new-key-received frame to the first wireless device to inform that the new key has been received.

In detail, the key transfer module 123 transmits the new-key-send frame with the encrypted new key according to the privacy key of the first wireless device 100. The new-key-send frame is the management frame 1000 with the challenge text 3000. Referring to FIG. 5, the beacon type 3100 is set to 3, indicating the type of the new-key-send frame. The key length 3200 indicates lengths of the security type 3300 and the encrypted key 3400. The security type 3300 is set to 1, indicating the new key is a WEP key. The encrypted key 3400 is the new key encrypted with the public key of the second wireless device 200. The digital signature length 3500 is a length of the digital signature 3600. The digital signature 3600 is a digital signature encrypted with the privacy key of the first wireless device 100.

The key transfer module 223 receives the new-key-send frame, and parses the new-key-send frame to obtain the new key according to the public key of the first wireless device 100 and the privacy key of the second wireless device 200. In this embodiment, the key transfer module 223 checks the digital signature 3600 of the new-key-send frame according to the public key of the first wireless device 100, and then decrypts the encrypted key 3400 with the privacy key of the second wireless device 200, thereby obtaining the new key.

Then, the key transfer module 223 transmits a new-key-received key to the second wireless device 200 according to the privacy key of the second wireless device 200. The new-key-received frame is the management frame 1000 with the challenge text 2000. Referring to FIG. 4, the beacon type 2100 of the challenge text 2000 is set to 4, indicating the type of the new-key-received frame. The acknowledgement result 2200 is set to 0, indicating the new key has been received. The digital signature length 2300 indicates a length of the digital signature 2400. The digital signature 2400 is a digital signature encrypted with the privacy key of the second wireless device 200.

The key transfer module 123 receives the new-key-received frame, and checks the new-key-received frame according to the public key of the second wireless device 200. In the exemplary embodiment, the key transfer module 123 checks the digital signature 2400 of the new-key-received frame according to the public key of the second wireless device 200.

In other embodiments, the new key may also be generated by the key generation module 222 of the second wireless device 200, and accordingly the functions of the key transfer modules 123 and 223 may be exchanged.

Thus, the first wireless device 100 and the second wireless device 200 use the new key for data traffic.

The first wireless device 100 and the second wireless device 200 can determine whether a disconnection therebetween has occurred when using the new key for data traffic. If disconnection has not occurred, the first wireless device 100 and the second wireless device 200 determine whether a key exchange is needed. Either of the exchange determination modules 130 and 230 can determine whether the key exchange is needed. In the exemplary embodiment, the exchange determination modules 130 and 230 may simultaneously determine whether the key exchange is needed, or only one of the exchange determination modules 130 and 230 determines whether the key exchange is needed. Due to the same function of the exchange determination modules 130 and 230, only the exchange determination module 130 is described hereinafter.

In the exemplary embodiment, the exchange determination module 130 determines whether the key exchange is needed according to a predetermined exchange frequency.

In other embodiments, the exchange determination module 130 may determine whether the key exchange is needed according to a user instruction. For example, users may give a user instruction via a button or other means, and then the exchange determination module 124 receives the user instruction and determines the key exchange is needed.

If the key exchange is needed, the first wireless device 100 goes on to transmit a request-key-change frame to the second wireless device 200.

If the key exchange is not needed, the first wireless device 100 and the second wireless device 200 go on using the new key for data traffic until a disconnection occurs.

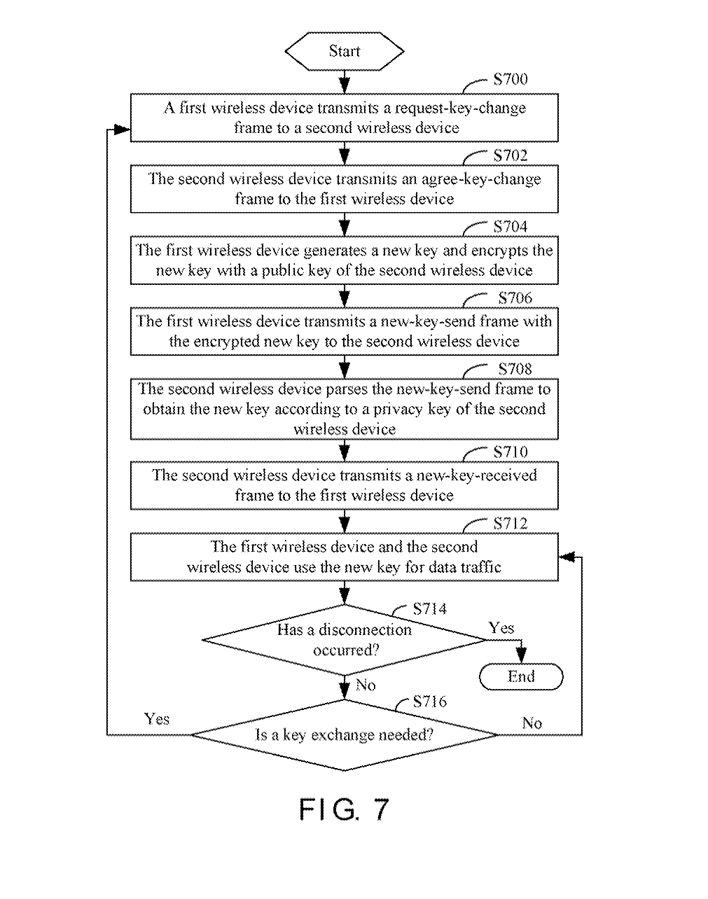

FIG. 7 is a flowchart of a key exchange method of an exemplary embodiment of the invention.

In step S700, the first wireless device 100 transmits a request-key-exchange frame to the second wireless device 200 to request to exchange a key.

In step S702, the second wireless device 200 transmits an agree-key-change frame to the first wireless device 100 to agree to exchange a key.

In step S704, the first wireless device 100 generates a new key and encrypts the new key with a public key of the second wireless device 200.

In step S706, the first wireless device 100 transmits a new-key-send frame with the encrypted new key to the second wireless device 200.

In step S708, the second wireless device 200 parses the new-key-send frame to obtain the new key according to a privacy key of the second wireless device 200.

In step S710, the second wireless device 200 transmits a new-key-received frame to the first wireless device 100 to inform that the new key has been received.

In step S712, the first wireless device 100 and the second wireless device 200 use the new key for data traffic.

In step S714, the first wireless device 100 determines whether a disconnection between the first wireless device 100 and the second wireless device 200 has occurred.

In other embodiments, the second wireless device 200 may, instead of the first wireless device 10, determine whether disconnection has occurred.

If disconnection has occurred, in step S716, the first wireless device 100 determines whether a key exchange is needed.

If the key exchange is not needed, going back to step S712, the first wireless device 100 and the second wireless device 200 go on using the new key for data traffic.

If the key exchange is needed, going back to step S700, the first wireless device 100 goes on to transmit a request-key-change frame to the second wireless device 200 until disconnection occurs.

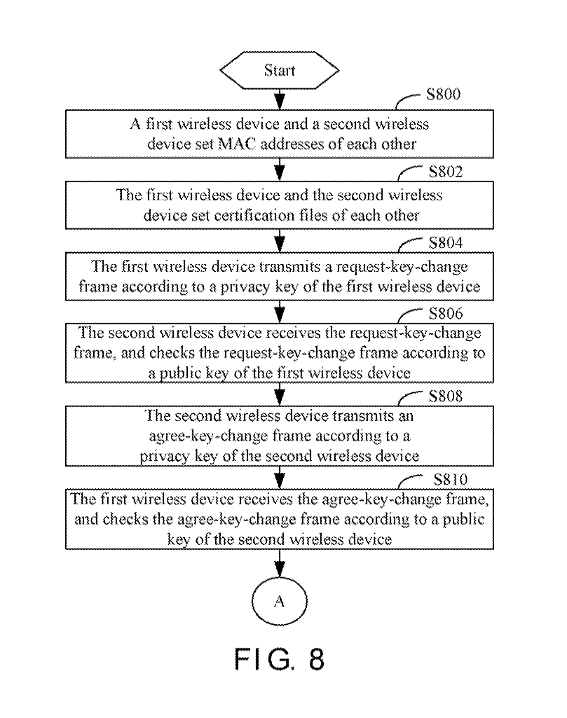

FIG. 8 is a flowchart of details of certain initial steps shown in FIG. 7. Steps 800-806 correspond to step 700 shown in FIG. 7, and steps 808 and 810 correspond to step 702 shown if FIG. 7.

In step S800, the first wireless device 100 and the second wireless device 200 set MAC addresses of each other. In the exemplary embodiment, the first wireless device 100 and the second wireless device 200 establishes a WDS connection therebetween, and thus set the MAC addresses of each other.

In another embodiment, the first wireless device 100 and the second wireless device 200 may establish a point-to-point connection therebetween, and accordingly do not need to set the MAC addresses of each other.

In step S802, the first wireless device 100 and the second wireless device 200 set certification files of each other. In the exemplary embodiment, the certification file of the second wireless device 200 includes a public key of the second wireless device 200, and the certification file of the first wireless device 100 includes a public key of the first wireless device 100.

In step S804, the first wireless device 100 transmits a request-key-change frame to the second wireless device 200 according to a privacy key of the first wireless device 100. In the exemplary embodiment, the request-key-change frame is the management frame 1000 with the challenge text 2000. Referring to FIG. 4, the beacon type 2100 of the challenge text 2000 is set to 1, indicating the type of the request-key-change frame. The digital signature length 2300 is a length of the digital signature 2400. The digital signature 2400 is a digital signature encrypted with the privacy key of the first wireless device 100.

In step S806, the second wireless device 200 receives the request-key-change frame, and checks the request-key-change frame according to a public key of the first wireless device 100. In the exemplary embodiment, the second wireless device 200 checks the digital signature 2400 of the request-key-change frame according to the public key of the first wireless device 100.

In step S808, the second wireless device 200 transmits an agree-key-change frame to the first wireless device 100 according to a privacy key of the second wireless device 200. In the exemplary embodiment, the agree-key-change frame is the management frame 1000 with the challenge text 2000. Referring to FIG. 4, the beacon type 2100 of the challenge text 2000 is set to 2, indicating the type of the agree-key-change frame. The acknowledgement result 2200 is set to 0, indicating acceptance of the key exchange request. The digital signature length 2300 indicates a length of the digital signature 2400. The digital signature 2400 is a digital signature encrypted with the privacy key of the second wireless device 200.

In step S810, the first wireless device 100 receives the agree-key-change frame, and checks the agree-key-change frame according to a public key of the second wireless device 200. In this embodiment, the first wireless device 100 checks the digital signature 2400 of the agree-key-change frame according to the public key of the second wireless device 200.

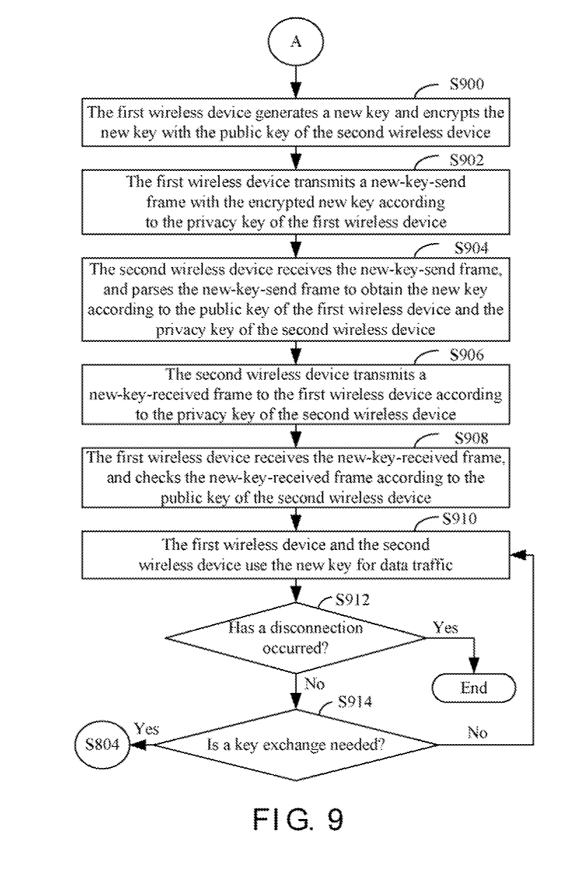

FIG. 9 is a flowchart of details of remaining steps shown in FIG. 7.

In step S900, which corresponds to step S704 of FIG. 7, the first wireless device 100 generates a new key and encrypts the new key with the public key of the second wireless device 200. In the exemplary embodiment, the new key is a WEP key. The first wireless device 100 generates the WEP key according to the IEEE 802.11 protocol.

In other embodiments, the new key may be a WPA-PSK or a WPA2-PSK, and the first wireless device 100 may generates the WPA-PSK or the WPA2-PSK according to the IEEE 802.11i protocol.

In step S902, which corresponds to step S706 of FIG. 7, the first wireless device 100 transmits a new-key-send frame with the encrypted new key according to the privacy key of the first wireless device 100. In the exemplary embodiment, the new-key-send frame is the management frame 1000 with the challenge text 3000. Referring to FIG. 5, the beacon type 3100 is set to 3, indicating the type of the new-key-send frame. The key length 3200 indicates lengths of the security type 3300 and the encrypted key 3400. The security type 300 is set to 1, indicating the new key is a WEP key. The encrypted key 3400 is the new key encrypted with the public key of the wireless device 200. The digital signature length 3500 is a length of the digital signature 3600. The digital signature 3600 is a digital signature encrypted with the privacy key of the first wireless device 100.

In step S904, which corresponds to step S708 of FIG. 7, the second wireless device 200 receives the new-key-send frame, and parses the new-key-send frame to obtain the new key according to the public key of the first wireless device 100 and the privacy key of the second wireless device 200. In this embodiment, the second wireless device 200 checks the digital signature 3600 of the new-key-send frame according to the public key of the first wireless device 100, and then decrypts the encrypted key 3400 of the new-key-send frame, thereby obtaining the new key.

In step S906, which corresponds to step S710 of FIG. 7, the second wireless device 200 transmits a new-key-received key to the first wireless device 100 according to the privacy key of the second wireless device 200. In the exemplary embodiment, the new-key-received frame is the management frame 1000 with the challenge text 2000. Referring to FIG. 4, the beacon type 2100 of the challenge text 2000 is set to 4, indicating the type of the new-key-received frame. The acknowledgement result 2200 is set to 0, indicating the new key has been received. The digital signature length 2300 indicates a length of the digital signature 2400. The digital signature 2400 is a digital signature encrypted with the privacy key of the second wireless device 200.

In step S908, the first wireless device 100 receives the new-key-received frame, and checks the new-key-received frame according to the public key of the second wireless device 200. In the exemplary embodiment, the first wireless device 100 checks the digital signature 2400 of the new-key-received frame according to the public key of the second wireless device 200.

In step S910, which corresponds to step S712 of FIG. 7, the first wireless device 100 and the second wireless device use the new key for data traffic.

In step S912, which corresponds to step S714 of FIG. 7, the first wireless device 100 determines whether a disconnection between the first wireless device 100 and the second wireless device 200 has occurred.

If disconnection has occurred, in step S914, which corresponds to step S716 of FIG. 7, the first wireless device 100 determines whether a key exchange is needed. In the exemplary embodiment, the first wireless device 100 determines that the key exchange is needed according to a predetermined exchange frequency.

In other embodiments, the first wireless device 100 may determine whether the key exchange is needed according to a user instruction.

If the key exchange is needed, then as detailed in step S804, the first wireless device 100 transmits a request-key-change frame to the second wireless device 200.

If the key exchange is not needed, then as detailed in step S910, the first wireless device 100 and the second wireless device 200 continue using the new key for data traffic until a disconnection occurs.

In the embodiments of the present invention, the first wireless device 100 and the second wireless device 200 exchange a key via a 4 way handshake that includes transceiving the request-key-change frame, the agree-key-change frame, the new-key-send frame, and the new-key-received frame. In addition, the new key is exchanged via a public/privacy key algorithm. That is, the first wireless device 100 encrypts the new key with the public key of the second wireless device 200, and the second wireless device 200 decrypts the encrypted new key with the privacy key of the second wireless device 200 to obtain the new key. Thus, the first wireless device 100 automatically exchanges the new key with the second wireless device 200 in security, thereby establishing a connection therebetween in security.

Furthermore, all of the request-key-change frame, the agree-key-change frame, the new-key-send frame, and the new-key-received frame transmitted between the first wireless device 100 and the second wireless device 200 are added digital signatures, so secure communication is assured.

Moreover, the first wireless device 100 and the second wireless device 200 dynamically exchange a key therebetween according to a predetermined exchange frequency, and thus the communication security therebetween is further improved.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A wireless device, for exchanging keys with another wireless device, the wireless device comprising:
a key request module, for requesting to exchange a key by transmitting a request-key-change frame to the another wireless device;
a key generation module, for generating a new key when the key exchange request is successful; and
a key transfer module, for encrypting the new key with a public key of the another wireless device, and transmitting a new-key-send frame with the encrypted new key to the another wireless device.

2. The wireless device as described in claim 1, wherein the key request module is for transmitting the request-key-change frame to the another wireless device according to a privacy key of the wireless device; the key transfer module is for encrypting the new key with the public key of the another wireless device, and transmitting the new-key-send frame with the encrypted new key according to the privacy key of the wireless device.

3. The wireless device as described in claim 2, wherein the request-key-change frame comprises a beacon type, a digital signature length, and a digital signature; the beacon type indicates a type of the request-key-change frame; the digital signature length indicates a length of the digital signature; the digital signature is a digital signature encrypted with the private key of the wireless device.

4. The wireless device as described in claim 2, wherein the new-key-send frame comprises a beacon type, a key length, a security type, an encrypted key, a digital signature length, and a digital signature; the beacon type indicates a type of the new-key-send frame; the key length indicates lengths of the security type and the encrypted key; the security type indicates a type of the new key; the encrypted key indicates the new key encrypted with the public key of the another wireless device; the digital signature length indicates a length of the digital signature; the digital signature is a digital signature encrypted with the privacy key of the wireless device.

5. The wireless device as described in claim 2, wherein the key request module is also for receiving a request-key-change frame from the another wireless device, and checking the request-key-change frame according to the public key of the another wireless device; the key transfer module is also for receiving a new-key-send fame with an encrypted new key from the another wireless device, and parsing the new-key-send frame to obtain the new key according to the public key of the another wireless device and the privacy key of the wireless device.

6. The wireless device as described in claim 1, wherein the key request module is also for agreeing to exchange a key by transmitting an agree-key-change frame to the another wireless device; the key transfer module is also for informing the another wireless device that the new key has been received by transmitting a new-key-received frame to the another wireless device.

7. The wireless device as described in claim 6, wherein the agree-key-change frame comprises a beacon type, an acknowledgement result, a digital signature length, and a digital signature; the beacon type indicates a type of the agree-key-change frame; the acknowledgement result indicates that the key exchange request is accepted; the digital signature indicates a length of the digital signature; the digital signature is a digital signature encrypted with the private key of the wireless device.

8. The wireless device as described in claim 6, wherein the new-key-received frame comprises a beacon type, an acknowledgement result, a digital signature length, and a digital signature; the beacon type indicates a type of the new-key-received frame; the acknowledgement result indicates that the new key has been received; the digital signature indicates a length of the digital signature; the digital signature is a digital signature encrypted with the private key of the wireless device.

9. The wireless device as described in claim 6, wherein the key request module is also for receiving an agree-key-change frame from the another wireless device, and checking the agree-key-change frame according to the public key of the another wireless device; the key transfer module is also for receiving a new-key-received key from the another wireless device, and checking the new-key-received key according to the public key of the another wireless device.

10. The wireless device as described in claim 1, further comprising:
a setting module, for setting a media access control (MAC) address and a certification file of the another wireless device, wherein the certification file comprising a public key of the another wireless device; and
an exchange determination module, for determining whether a key exchange is needed.

11. A key exchange method, for exchanging keys between/among a plurality of wireless devices, comprising:
transmitting a request-key-change frame from a first wireless device to a second wireless device to request to exchange a key;
transmitting an agree-key-change frame from the second wireless device to the first wireless device to agree to exchange a key;
generating a new key and encrypting the new key with a public key of the second wireless device by the first wireless device;
transmitting a new-key-send frame with the encrypted new key from the first wireless device to the second wireless device;
parsing the new-key-send frame to obtain the new key according to a privacy key of the second wireless device by the second wireless device; and
transmitting a new-key-received frame from the second wireless device to the first wireless device to inform the first wireless device that the new key has been received.

12. The key exchange method as described in claim 11, further comprising:
using the new key for data traffic between the first wireless device and the second wireless device;
determining whether a key exchange is needed; and
go on to transmit a request-key-change frame from the first wireless device to the second wireless device if the key exchange is needed.

13. The key exchange method as described in claim 11, further comprising:
setting media access control (MAC) addresses of each other by the first wireless device and the second wireless device; and
setting certification files of each other by the first wireless device and the second wireless device.

14. The key exchange method as described in claim 11, wherein transmitting a request-key-change frame from the first wireless device to the second wireless device comprises:
transmitting the request-key-change frame from the first wireless device to the second wireless device according to a privacy key of the first wireless device; and
receiving the request-key-change frame, and checking the request-key-change frame according to a public key of the first wireless device by the second wireless device.

15. The key exchange method as described in claim 11, wherein transmitting an agree-key-change frame from the second wireless device to the first wireless device comprises:
transmitting the agree-key-change frame from the second wireless device to the first wireless device according to the privacy key of the second wireless device; and
receiving the agree-key-change frame, and checking the agree-key-change frame according to the public key of the second wireless device by the first wireless device.

16. The key exchange method as described in claim 11, wherein transmitting a new-key-send frame with the encrypted new key from the first wireless device to the second wireless device comprises:
transmitting the new-key-send frame with the encrypted new key from the first wireless device to the second wireless device according to the privacy key of the first wireless device.

17. The key exchange method as described in claim 16, wherein parsing the new-key-send frame to obtain the new key according to the privacy key of the second wireless device comprises:
receiving the new-key-send frame, and parsing the new-key-send frame to obtain the new key according to the public key of the first wireless device and the privacy key of the second wireless device by the second wireless device.

18. The key exchange method as described in claim 11, wherein transmitting a new-key-received frame from the second wireless device to the first wireless device comprises:
transmitting the new-key-received frame from the second wireless device to the first wireless device according to the privacy key of the second wireless device; and
receiving the new-key-received frame, and checking the new-key-received frame according to the public key of the second wireless device by the first wireless device.

19. A method for communicating and data-exchanging between a plurality of wireless devices in a protective wireless communication system, comprising:
requesting by a first wireless device to exchange a key with a second wireless device;
agreeing by said second wireless device to exchange said key with said first wireless device;
generating a new key for exchange by said first wireless device;
encrypting said new key via a certification file of said second wireless device by said first wireless device;
transmitting said encrypted new key from said first wireless device to said second wireless device;
acquiring said new key in said second wireless device by means of parsing said encrypted new key according to said certification file of said second wireless device; and
establishing protective data communication between said first and second wireless devices according to said new key.

20. The method as described in claim 19, wherein said certification file comprises a public key of said second wireless device used to encrypt said new key, and a private key of said second wireless device corresponding to said public key used to parse said encrypted new key.
